(19) United States
(12) Patent Application Publication
(10) Pub. No.: US 2016/0368028 A1
(43) Pub. Date: Dec. 22, 2016

(54) PARTS WASHER WITH FAST-OPENING FLEXIBLE DOOR

(71) Applicant: FIVES CINETIC CORP., Farmington Hills, MI (US)

(72) Inventors: Kevin Heikkinen, Milford, MI (US); Ken Carmack, Howell, MI (US); Scott Paxson, Canton, MI (US)

(21) Appl. No.: 14/745,611

(22) Filed: Jun. 22, 2015

(51) Int. Cl. B08B 3/02

(52) U.S. Cl. CPC B08B 3/02

(57) ABSTRACT

A parts washing system includes a plurality of walls defining a chamber. A washing apparatus is disposed within the chamber for washing a part. At least one of the walls defines an opening. The system also includes a door movable from an open position for allowing access to the chamber to a closed position for preventing access to the chamber. The door comprises a flexible material. An electric motor is operatively connected to the door for actuating movement of the door from the closed position to the open position at a velocity faster than 20 inches per second.

### TECHNICAL FIELD

The technical field relates generally to systems for washing industrial parts.

### BACKGROUND

Industrial parts washers for washing and/or drying various parts, components, and/or other items (hereafter “parts”) typically include numerous chambers defined by separating walls. One or more doors are utilized to move these parts between the chambers. For example, a part may move from a first chamber for washing the part, through a door, to a second chamber for drying the part.

Typically, the walls and doors are formed of metal, e.g., stainless steel or aluminum. As such, the doors are heavy and may be opened or closed using hydraulic and/or pneumatic actuators. Accordingly, these doors are often slow to open and close, which slows down throughput of the washing unit. Furthermore, the doors are susceptible to denting and other damage due to malfunctions in robots or other conveyors that shuttle the parts between the various chambers.

As such, it is desirable to present a parts washer with doors that are faster to open and close. Further, it is desirable to present a parts washer with doors that resist damage. In addition, other desirable features and characteristics will become apparent from the subsequent summary and detailed description, and the appended claims, taken in conjunction with the accompanying drawings and this background.

### BRIEF SUMMARY

In one embodiment, a parts washing system includes a plurality of walls defining a chamber. A washing apparatus is disposed within the chamber for washing a part. At least one of the walls defines an opening. The system also includes a door movable from an open position for allowing access to the chamber to a closed position for preventing access to the chamber. The door comprises a flexible material.

In another embodiment, a parts washing system includes a plurality of walls defining a chamber. A washing apparatus is disposed within the chamber for washing a part. At least one of the walls defines an opening. The system also includes a door movable from an open position for allowing access to the chamber to a closed position for preventing access to the chamber. The system further includes an electric motor operatively connected to the door for actuating movement of the door from the closed position to the open position at a velocity faster than 20 inches per second.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram of a part washing system according to one embodiment;

FIG. 2 is a perspective view of a portion of the part washing system according to one embodiment;

FIG. 3 is a cross-sectional side view of a portion of the part washing system according to one embodiment;

FIG. 4 is a cross-sectional top view of a portion of the part washing system according to one embodiment;

FIG. 5 is a perspective view of a portion of the part washing system according to one embodiment showing a door in a closed position;

FIG. 6 is a perspective view of the portion of the part washing system shown in FIG. 5 showing the door in an open position; and

FIG. 7 is a cross-sectional side view of a portion of the part washing system showing a spindle disposed through a hole.

### DETAILED DESCRIPTION

Referring to the figures, wherein like numerals indicate like parts throughout the several views, a part washing system 100 is shown and described herein.

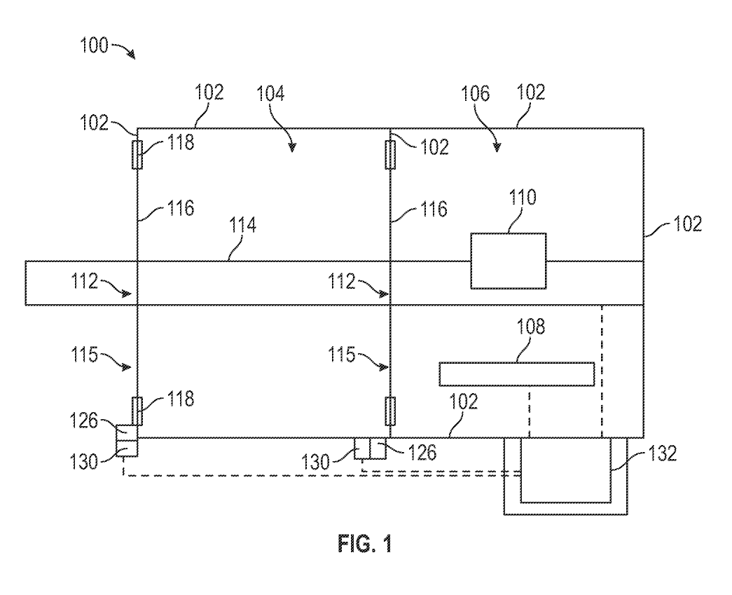

Referring to FIG. 1, the parts washing system 100 includes a plurality of walls 102 defining at least one chamber 104, 106. In the illustrated embodiment, the walls 102 define a first chamber 104 and a second chamber 106. It should be appreciated that the walls 102 may define any number of chambers 104, 106. It should also be appreciated that the term “walls” 102, as used herein, refers to any structural divider, including, but not limited to, walls, ceilings, and floors.

A washing apparatus 108 is disposed within the at least one chamber 104, 106 for washing a part 110. In the embodiments shown in the figures, the washing apparatus 108 is disposed within the second chamber 106. The washing apparatus 108 includes various nozzles, hoses, pumps, and other components (not shown), as needed to wash the part 110, as appreciated by those skilled in the art.

At least one of the walls 102 defines an opening 112. The opening 112 allows ingress and/or egress from at least one of the chambers 104, 106. Of course, the part washing system 100 may include a plurality of openings 112. Furthermore, one of the walls 112 may include multiple openings 112. In the illustrated embodiment, the opening 112 measures about 42 inches (1.07 m) wide and 48 inches (1.22 m) high. However, in other embodiments, the opening 112 may vary in size based on numerous factors, including, but not limited to, the size of the part 110 that is to be washed.

A conveyance mechanism 114 may be utilized for conveying parts 110 into, out of, and/or through the parts washing system 100. The conveyance mechanism 114 may include, but is certainly not limited to, a gantry, a conveyor, and a robot. Of course, multiple conveyance mechanisms 114 may be utilized as is well appreciated by those skilled in the art.

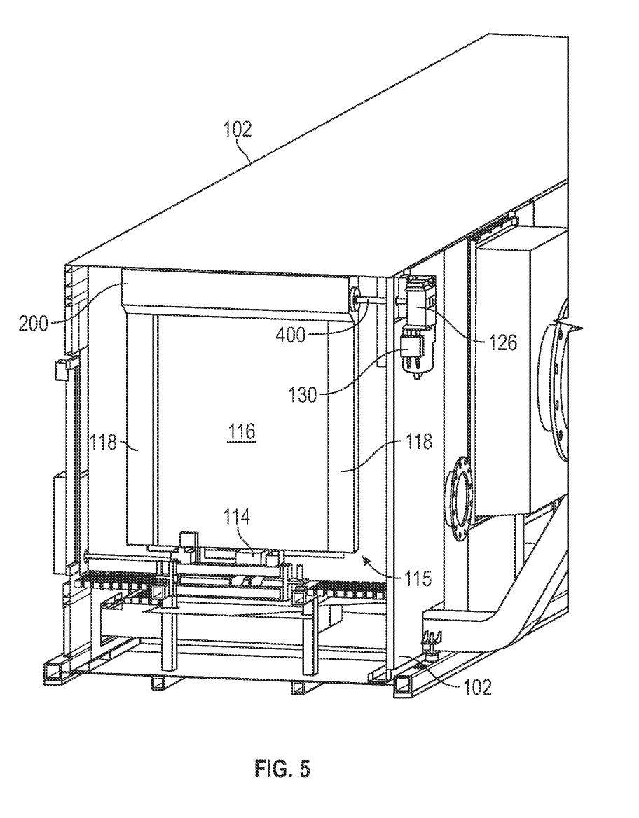

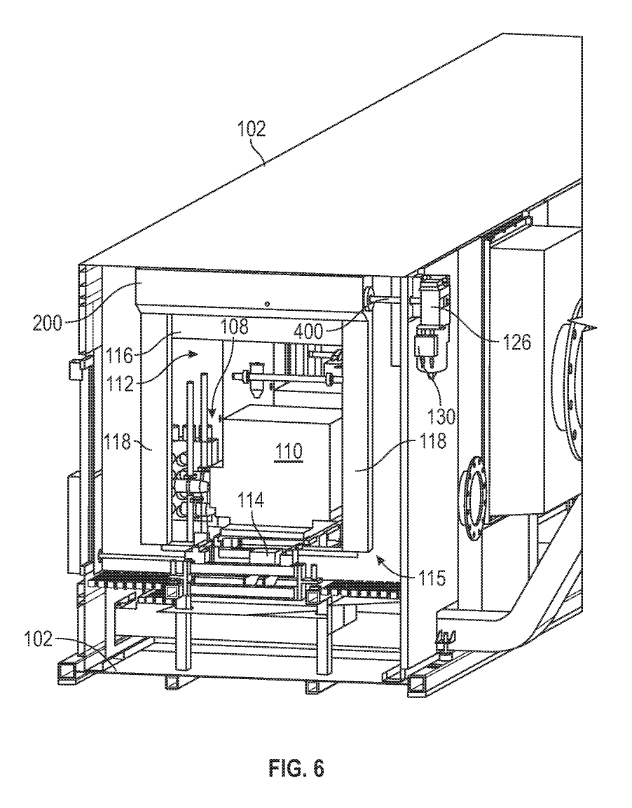

The system 100 further includes a door assembly 115. The door assembly includes a door 116 disposed adjacent the opening 112. The door 116 is movable from an open position for allowing access to the chamber, as shown in FIG. 5, to a closed position for preventing access to the chamber, as shown in FIG. 6.

The door 116 comprises a flexible material (not separately numbered). The flexible material forms the primary barrier that is disposed in and/or adjacent the opening 112. Ideally, the flexible material is capable of flexing, bending, and/or stretching without easily breaking, being permanently dented, or having holes easily formed therethrough. In one embodiment, the flexible material comprises polyvinyl chloride (“PVC”). However, other suitable materials may be utilized. The flexible material of the door 116 may be opaque, transparent, or a combination thereof.

By utilizing the flexible material, damage to the door 116 due to improper conveyance of the part and/or malfunction of the conveyance mechanism 112 is reduced. This is because the flexible material is less likely to be dented, torn, broken, or otherwise punctured than traditional metal doors.

In the illustrated embodiment, the door 116 has a width of at least 42 inches (1.07 m) and a height of at least 48 inches (1.22 m) to completely cover the opening 112 when in the closed position. The door assembly 115 may also include a pair of tracks 118. The door 116 slides in, and is retained by, the tracks 118 when moving between the open position and the closed position.

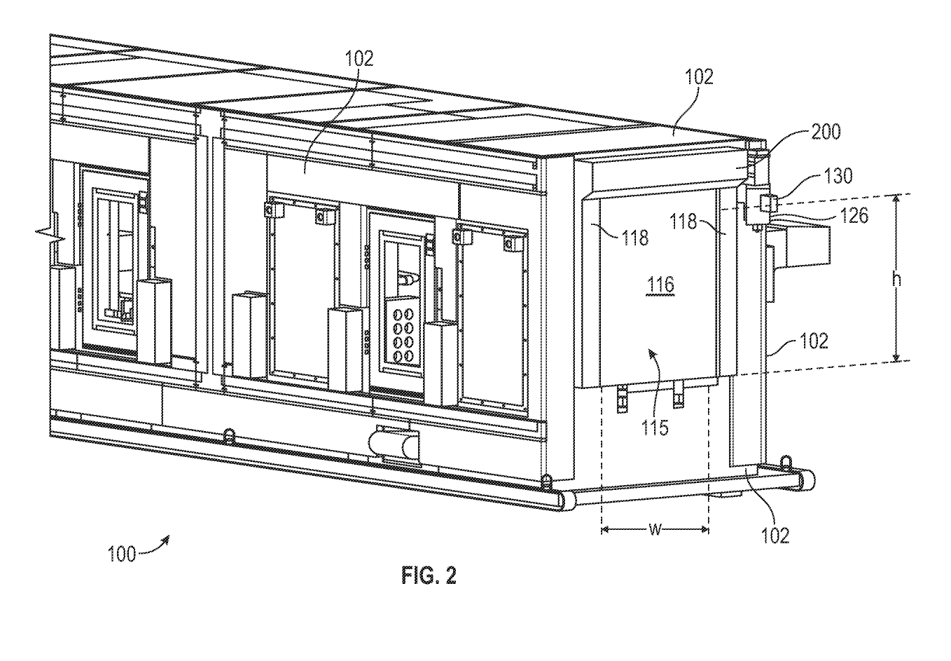

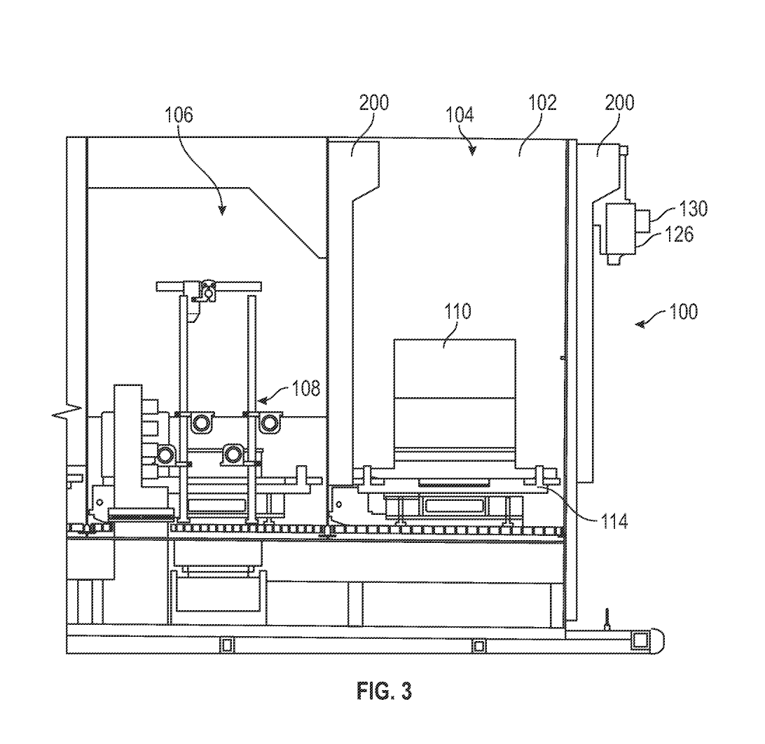

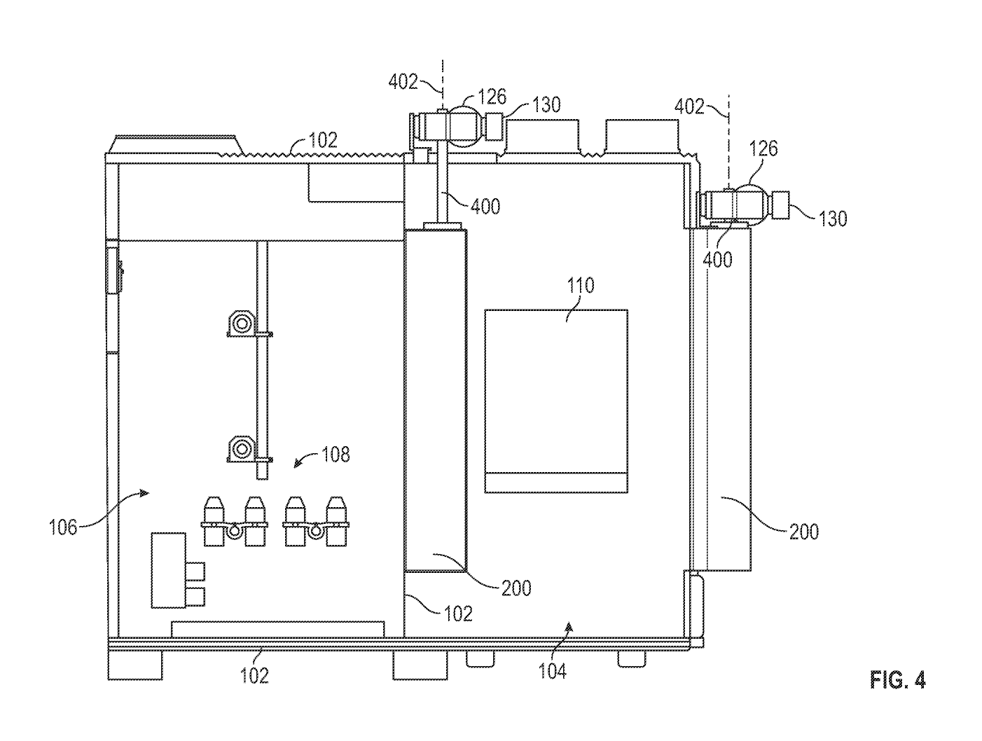

The door assembly 115 may also include a spindle 400, as best shown in FIGS. 4-7. The spindle 400 is operatively connected to a top end (not numbered) of the door 116. The spindle 400 is rotatable about an axis 402 for moving the door 116 between the closed position and the open position. Specifically, a portion the door 116 wraps around the spindle 400 when going from the closed position to the open position and unwraps from the spindle 400 when going from the open position to the closed position. The door assembly 115 may also include an enclosure 200, as shown in FIGS. 2-6, at least partially enclosing the spindle 400 and enclosing at least part of the door 116 when in the open position.

Referring again to FIG. 1, the system 100 may include an electric motor 126 operatively connected, i.e., coupled, to the door 116 for actuating movement of the door between the closed position and the open position, and vice-versa. In the embodiments shown in FIGS. 4-6, the electric motor 126 is operatively connected to the spindle 400. As such, the electric motor 126 is configured to rotate the spindle 400, which, in turn, actuates movement of the door 116 between the closed position and the open position and vice-versa.

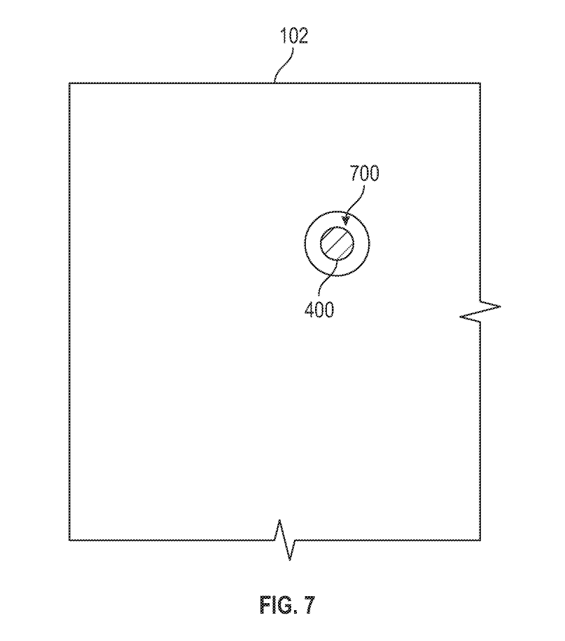

In some embodiments of the system 100, at least one of the walls 102 defines a hole 700, as shown in FIG. 7, and the spindle 400 is disposed through the hole 700. As such, the electric motor 126 may be positioned outside of the chamber 104, as best shown in FIGS. 4-6. This configuration prevents water, solvents, etc. from coming into direct and/or repeated contact with the electric motor 126. A seal and/or bearing (not shown) may be disposed within the hole 700 to further seal the wall 102 and/or support rotational movement of the spindle 400.

Referring again to FIG. 1, the system 100 may also include a motor controller 130 electrically connected to the electric motor 126 for controlling operation of the electric motor 126. The motor controller 130 may include a processor (not shown), e.g., a microprocessor, and/or other electronics. In one embodiment, the processor is capable and configured to perform various mathematical operations and execute a serious of instructions based on various inputs to produce various outputs. In other embodiments, the motor controller 130 may be configured to operate without a microprocessor, e.g., with various electronic components and/or relays.

The system 100 may also include a system controller 132. The system controller 132 may include a processor (not shown), e.g., a microprocessor, and/or other electronics. In one embodiment, the processor is capable and configured to perform various mathematical operations and execute a serious of instructions based on various inputs to produce various outputs. In other embodiments, the motor controller 130 may be configured to operate without a microprocessor, e.g., with various electronic components and/or relays.

Referring to FIG. 1, the system controller 132 is in communication with the washing apparatus 108 to control the washing apparatus 108. The system controller 132 may also be in communication with the conveyance mechanism 114 and configured to control operation of the conveyance mechanism 114. In the embodiment shown in FIG. 1, the system controller 132 is also in communication with the motor controllers 130. As such, the system controller 132 may exhibit control over the electric motors 126, as described below.

In the illustrated embodiment, the controllers 130, 132 may be in communication with each other to coordinate actions. For example, the system controller 132 may signal that the washing apparatus 106 is ready to accept a part 110. In response, the electric motor 126, controlled by the motor controller 130, may be operated to move the door into the open position. A signal may then be issued by one of the controllers 130, 132 to indicate that the door 116 is in the open position. In response, the conveyance mechanism 114 may the move a part into the chamber 106. Once the part 110 is in the chamber 106, a signal indicating as such may be issued. In response to this signal, the motor controller 130 may operate the electric motor to move the door 11 to the closed position. The system 100 may include other controllers (not shown) and/or processors (not shown) configured to operate the electric motor 126 and/or other aspects of the washing apparatus 108 and/or the conveyance mechanism 114. Alternatively, a single controller may be utilized to control operations of the electric motor 126, the washing apparatus 108, and/or the conveyance mechanism 114.

In one embodiment of the system 100, the door 116 opens at a velocity faster than 20 inches per second (0.508 m/s). That is, the door 116 moves from the closed position to the open position at a rate of 20 inches per second (0.508 m/s). In the illustrated embodiment, where the door 116 has a height of at least 48 inches, the door may move from the closed position to the open position in less than 2.4 seconds.

In the illustrated embodiment of the system 100, the door 116 opens at a velocity faster than 40 inches per second (1.016 m/s). That is, the door 116 moves from the closed position to the open position at a rate of 40 inches per second (1.016 m/s). As such, the door 116, which has a height of about 48 inches, moves from the closed position to the open position in less than 1.2 seconds. The door 116 of the illustrated embodiment also closes at a velocity faster than 40 inches per second (1.016 m/s). As such, the door 116 also moves from the open position to the closed position in less than 1.2 seconds.

Operating the door 116 quickly, i.e., faster than 20 inches per second, has several advantages of prior art systems. First, the systems 100 of the illustrated embodiments is able to wash parts faster than prior art systems, as the wait time for the door 116 to open and/or close is reduced. Thus, overall throughput of parts 110 through the system 100 is increased. Second, since the door 116 operates quickly, there is a reduced chance for collision with the part 110 and/or the conveyance mechanism 112, as the likelihood of the door remaining in the closed position is reduced.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

1. A parts washing system comprising:
a plurality of walls defining a chamber;
a washing apparatus disposed within said chamber for washing a part;
at least one of said walls defining an opening; and
a door movable from an open position for allowing access to said chamber to a closed position for preventing access to said chamber;
said door comprising a flexible material.

2. The system as set forth in claim 1 further comprising a spindle operatively connected to a top end of said door and rotatable about an axis for moving said door between the closed position and the open position.

3. The system as set forth in claim 2 further comprising an electric motor operatively connected to said spindle for rotating said spindle for actuating movement of said door between the closed position and the open position.

4. The system as set forth in claim 3 wherein said electric motor is disposed outside of said chamber.

5. The system as set forth in claim 4 wherein at least one of said walls defines a hole and wherein said spindle is disposed through said hole.

6. The system as set forth in claim 3 further comprising a controller electrically connected to said electric motor for controlling operation of said electric motor.

7. The system as set forth in claim 1 wherein said door opens at a velocity faster than 20 inches per second.

8. The system as set forth in claim 1 wherein said door opens at a velocity faster than 40 inches per second.

9. A parts washing system comprising:
a plurality of walls defining a chamber;
a washing apparatus disposed within said chamber for washing a part;
at least one of said walls defining an opening;
a door movable from an open position for allowing access to said chamber to a closed position for preventing access to said chamber;
wherein said door comprises a flexible material; and
an electric motor operatively connected to said door for actuating movement of said door from the closed position to the open position at a velocity faster than 20 inches per second.

10. The system as set forth in claim 9 wherein said electric motor moves said door from the closed position to the open position at a velocity faster than 40 inches per second.

11. The system as set forth in claim 9 further comprising a spindle operatively connected to a top end of said door and rotatable about an axis for moving said door between the closed position and the open position.

12. The system as set forth in claim 11 wherein said electric motor is disposed outside of said chamber.

13. The system as set forth in claim 12 wherein at least one of said walls defines a hole and wherein said spindle is disposed through said hole.

14. The system as set forth in claim 9 further comprising a controller electrically connected to said electric motor for controlling operation of said electric motor.

15. (canceled)

16. A parts washing system comprising:
a plurality of walls defining a chamber;
a washing apparatus disposed within said chamber for washing a part;
at least one of said walls defining an opening; and
a door movable from an open position for allowing access to said chamber to a closed position for preventing access to said chamber;
said door comprising a flexible material;
a spindle operatively connected to a top end of said door and rotatable about an axis for moving said door between the closed position and the open position.
wherein at least one of said walls defines a hole and wherein said spindle is disposed through said hole; and
an electric motor disposed outside of said chamber and operatively connected to said spindle and configured to actuate movement of said spindle such that said door moves from the closed position to the open position at a velocity faster than 40 inches per second.
